SEQUENCE LISTING (6 sequences)

SEQ ID NO: 1 - DNA, 20 bp, Artificial Sequence
  Primer CMF472
ctcaccaggtccagacacaa

SEQ ID NO: 2 - DNA, 20 bp, Artificial Sequence
  Primer CMR654
ccctctaagaagccagcgta

SEQ ID NO: 3 - DNA, 20 bp, Artificial Sequence
  Primer GLF162
tctgtgcctgcgtttatcac

SEQ ID NO: 4 - DNA, 20 bp, Artificial Sequence
  Primer GLR443
gacaagcctccaagtccaag

SEQ ID NO: 5 - DNA, 20 bp, Artificial Sequence
  Primer PLF502
gcttgaggtttggacttgga

SEQ ID NO: 6 - DNA, 18 bp, Artificial Sequence
  Primer PLF626
cgctcgttggtgaatgga

(19) United States
(12) Patent Application Publication
(10) Pub. No.: US 2008/0016758 A1
(43) Pub. Date: Jan. 24, 2008

(54) Method for the production of mushroom mycelia using starch pulp liquid medium

(75) Inventors: Seokhwan Hwang, Pohang-si (KR); Seung Yong Lee, Seogwipo-si (KR); Hyo Kwan Bae, Ulsan (KR)

Correspondence Address: SUGHRUE MION, PLLC, 2100 PENNSYLVANIA AVENUE, N.W., SUITE 800, WASHINGTON, DC, 20037, US

(73) Assignees: POSTECH FOUNDATION; POSTECH ACADEMY-INDUSTRY FOUNDATION

(21) Appl. No.: 11/487,575

(22) Filed: Jul. 17, 2006

(30) Foreign Application Priority Data
Jul. 18, 2005 (KR) 10-2006-0064836

(51) Int. Cl. A01G 1/04

(52) U.S. Cl. 47/1.1

(57) ABSTRACT

A method for the production of mushroom mycelia comprising cultivating mushroom mycelia in a liquid medium containing starch pulp as the s sole growth substrate is provided together with a unique method for quantitatively determining the amount of mycelia during the cultivation.

### FIELD OF THE INVENTION

The present invention relates to a method for the production of mushroom mycelia using a liquid medium comprising starch pulp as the sole growth substrate.

### BACKGROUND OF THE INVENTION

Although the fruit body of a mushroom is a functional food having various beneficial physiological characteristics such as anticancer activity, the production thereof has proven to be not an easy task, requiring long-term cultivation under particular weather conditions.

Due to the recent report that mushroom mycelia is almost equal to the fruit body in terms of nutrient ingredients and physiologically active materials (Q. Fang and J. Zhong, Process Biochem., 37;769-774(2002); N. Hatvani, Int. J. Antimicrob. Agents, 17:71-74(2001); F. Yang, C. Liau, Process Biochem., 33:547-553(1998)), diverse researches have been conducted to cultivate mycelia instead of the fruit body. The growth of the mycelia is greatly influenced by the concentration of media, acidity(pH) and temperature.

Starch pulp, a by-product generated during starch production from corn or sweet potato, is viable as a satisfactory medium for cultivating mushroom mycelia. Every year, about 1.5 million tons of starch pulp is produced, and it is expected to increase continuously with the growth of starch production, which is currently disposed by land-filling and ocean dumping.

For this reason, various attempts have been made to recycle the starch pulp through the production of edible mushroom, compost/liquefied fertilizer, physiologically active material extract or activated carbon. It has also been actively studied to produce mushroom mycelia in solid/liquid media, but no practical process for producing mushroom mycelia using starch pulp alone has been attempted.

### SUMMARY OF THE INVENTION

Accordingly, it is a primary object of the present invention to provide an effective method for producing mushroom mycelia using starch pulp.

In accordance with one aspect of the present invention, there is provided a method for producing mushroom mycelia, comprising cultivating mushroom mycelia in a liquid medium containing starch pulp as the sole growth substrate.

### BRIEF DESCRIPTION OF THE DRAWINGS

The objects and features of the present invention will become apparent from the following description for the invention, when taken in conjunction with the accompanying drawings, which respectively show:

FIGS. 1A to 1C: graphs showing the quantity of mushroom mycelia gained from real-time quantitative PCR, wherein FIG. 1A is for the mycelia of Cordyceps militaris; FIG. 1B, the mycelia of Ganoderma lucidum; and FIG. 1C, the mycelia of Phellinus linteus;

FIGS. 2A to 2C: contour plots and three-dimensional diagrams of the response surfaces representing optimum conditions for producing the mycelia of Cordyceps militaris, Ganoderma lucidum and Phellinus linteus, respectively.

### DETAILED DESCRIPTION OF THE INVENTION

In accordance with the inventive method, mushroom mycelia having excellent anticancer and immune-restoring activities can be produced in a liquid medium comprising starch pulp as the sole growth substrate.

The production of mushroom mycelia can be maximized by controlling the cultivation conditions such as the concentration of media, acidity and temperature. Any starch pulp, including corn pulp, sweet potato pulp, sugar cane pulp and potato pulp, can be used in the present invention.

Examples of the mushroom mycelia which can be cultivated by the inventive method include the mycelia of Cordyceps militaris, e.g., Cordyceps militaris, C. sobolifera and C. sphecocephala, Gnoderma lucidum and Phellinus linteus. However, any mushroom mycelia can also be cultivated by the method of the present invention. Generally, the desirable conditions for the cultivation of mushroom mycelia in the present invention are: starch pulp concentration ranging from 20 to 45 g/l, pH ranging from 4.0 to 7.0, and temperature ranging from 20 to 35° C.

The optimum conditions for the cultivation of mushroom mycelia vary slightly depending on the mushroom species. For instance, optimum cultivation conditions are: starch pulp concentration of 30 to 40 g/l, pH of 5.3 to 5.9 and temperature of 20 to 26° C. for the Cordyceps militaris mycelia; starch pulp concentration of 35 to 45 g/l, pH of 4.3 to 4.8, and temperature of 22 to 28° C. for the Ganoderma lucidum mycelia; and starch pulp concentration of 24 to 30 g/l, pH of 6.3 to 6.5, and temperature of 26 to 32° C. for Phellinus linteus mycelia.

When mushroom mycelia are cultivated in liquid media, it is desirable to determine the precise quantity of mycelia during the course of cultivation, which can lead to the establishment of the most efficient cultivating conditions. The existing dry-weight method, which has been used for the quantitative analysis of microbes, is not suitable for quantifying mycelia grown in a medium having a high content of solid bodies, e.g., the starch pulp media. Accordingly, the growth of mycelia is quantified in the present invention by measuring their DNA content. Preferably, DNA content of mycelium is measured by real-time quantitative PCR (polymerase chain reaction) using species-specific primers capable of measuring the DNAs, preferably 18 s rDNA, of the mycelia.

The species-specific primers can be prepared by consulting the reported nucleotide sequence of 18 s rDNA of each mushroom mycelium. For instance, the primers of SEQ ID NOs: 1 and 2 can be used as primers specific for the Cordyceps militaris mycelia; the primers of SEQ ID NOs: 3 and 4, specific for Ganoderma lucidum mycelia; and the primers of SEQ ID NOs: 5 and 6, specific for Phellinus linteus mycelia.

The inventive method for producing mushroom mycelia using a liquid medium comprising starch pulp as the sole growth substrate has the advantages of using the starch pulp waste in the production of a high value-add product as well as enhancing the productivity and reducing the cultivation period of mushroom mycelia by optimizing the production process.

In the inventive liquid cultivation process of mycelia, it is easy to control the conditions such as pH, temperature and medium concentration, and so is the separation of mycelia from the medium. Moreover, the real-time quantitative PCR using primers specific for the DNA of mushroom mycelia makes it easy to optimize the cultivation process.

The following examples are intended to further illustrate the present invention without limiting its scope.

### EXAMPLE 1

### Establishment of Cultivating Conditions and the Method of Quantitatively Analyzing Mushroom Mycelia

(1) Mushroom Strain and the Starch Pulp Liquid Media

Cordyceps militaris (KCTC 6472), Ganoderma lucidum (KCTC 6283) and Phellinus linteus (KCTC 6719) strains were obtained from Korean Collection for Type Cultures (KCTC; KRIBB, Daejeon, Korea), and they were each subjected to subculture in a PDA (potato dextrose agar) medium at 25° C. while maintaining the exponential growth phase thereof.

A batch of corn starch pulp in the form of a paste was obtained from Corn Products Korea Inc. The corn starch pulp containing 90% water was dried at 60° C. for 24 hours and pulverized to obtain a powder. A predesigned amount of the powdered starch pulp thus obtained was suspended in 90 ml of distilled water to obtain a liquid medium having a starch pulp concentration ranging from 15 to 50 g/l. For example, a liquid medium having a pulp concentration of 30 g/l was prepared by dissolving 2.7 g of the starch pulp in 90ml of distilled water. The medium was subjected to high pressure sterilization at 121° C. and stored in an aseptic chamber until mushroom inoculation.

The peripheral region where the mushroom mycelia were most actively undergoing exponential growth on the PDA media was sampled by using a 5 mm-circular cutter and this cylindrical sample was inoculated into a PDB (potato dextrose broth) liquid medium, to be cultured for a week at 130 rpm and 25° C. The resulting liquid medium containing mushroom mycelia was homogenized and 10 re of the homogenized medium was inoculated to the above-produced liquid medium (90 m) comprising starch pulp.

(2) Quantitative Analysis of Mushroom Mycelia by Real-Time PCR

(2-1) Preparation of a Primer Set

Referring to the 18 s rDNA nucleotide sequences of Cordyceps militaris (KCTC 6472), Ganoderma lucidum (KCTC 6283) and Phellinus linteus (KCTC 6719) stored in the database of NCBI (National Center for Biotechnology Information, www.ncbi.nlm.nih.gov/), the following primer sets 1 to 3 were prepared.

Primer set 1: designed to specifically quantify 18 s rDNA of Cordyceps militaris (KCTC 6472) and produces an amplification product of 183 bp.

(SEQ ID NO: 1)

CMF472: 5′-CTCACCAGGTCCAGACACAA-3′

(SEQ ID NO: 2)

CMR654: 5′-CCCTCTAAGAAGCCAGCGTA-3′

Primer set 2: designed to specifically quantify 18 s rDNA of Ganoderma lucidum (KCTC 6283) and produces an amplification product of 282 bp.

(SEQ ID NO: 3)

GLF162: 5′-TCTGTGCCTGCGTTTATCAC-3′

(SEQ ID NO: 4)

GLR443: 5′-GACAAGCCTCCAAGTCCAAG-3′

Primer set 3: designed to specifically quantify 18 s rDNA of Phellinus linteus (KCTC 6719) and produces an amplification product of 124 bp.

(SEQ ID NO: 5)

PLF502: 5′-GCTTGAGGTTTGGACTTGGA-3′

(SEQ ID NO: 6)

PLF626: 5′-CGCTCGTTGGTGAATGGA-3′

(2-2) Preparation of Calibration Curves for each Primer set using Real-Time PCR

Calibration curves for each of the above three primer sets were prepared as follows. After cultivating mushroom mycelia in a PDB medium, the DNAs of mushroom mycelia were. extracted by the boiling extraction method (Makimura, K. et al., J. Med. Microbiol., 40, 358-364(1994)). The DNAs, after measuring their concentration, were subjected to 10-fold serial dilution to obtain a set of test samples. For each test sample, real-time PCR using a corresponding primer set was conducted as follows.

4 μl of SYBR Green I dye solution prepared by reacting with 14 μl of polymerase of the real-time PCR reaction kit obtained from LightCycler FastStart DNA Master^{PLUS} SYBR Green I, Roche Diagnostics Germany and the test sample was placed in a 4 μl-capillary tube, and 5 μl of sample DNA and 500 nM each of forward and reverse primers were added thereto. Sterilized distilled water was added to the mixture to a total volume of 20 μl. The real-time quantitative PCR reaction consisted of 4 steps: the 1^{st} step, Tag polymerase activation (94° C., 10 min); the 2^{nd} step, 40 cycles of denaturation (90° C., 10 sec), annealing and extension, wherein the annealing and extension conditions were varied as shown in Table 1; the 3^{rd} step, the ‘melting’ step, wherein the intensity of the fluorescence emitted by SYBR Green from the amplification products was measured while raising the temperature gradually from 65° C. to 94° C.; and the final step, cooling the amplification products to 40° C.

TABLE 1

| | | Conditions for real-time PCR | |
|---|---|---|---|
| Primer set | Name of Strains | Annealing | Extension |
| 1 | Cordyceps militaris | 64° C., 10 sec | 72° C., 8 sec |
| 2 | Ganoderma lucidum | 62° C., 10 sec | 72° C., 12 sec |
| 3 | Phellinus linteus | 62° C., 10 sec | 72° C., 6 sec |

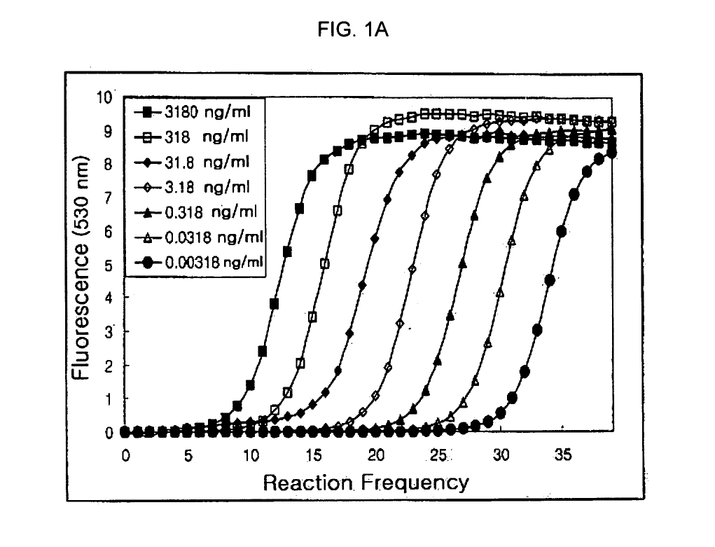

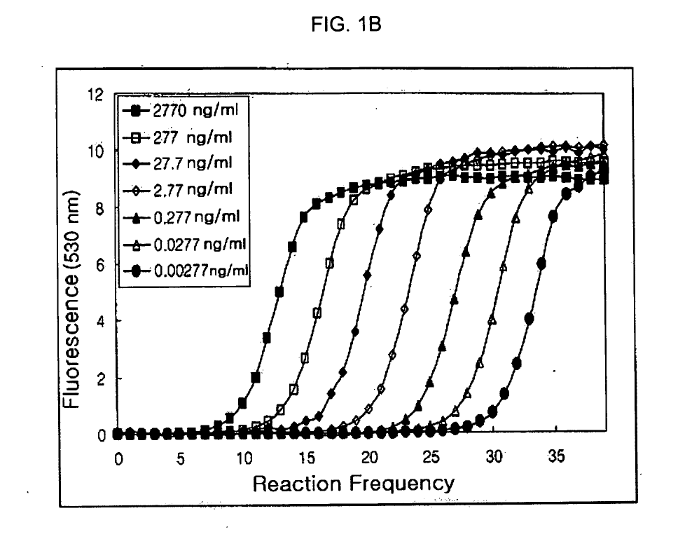

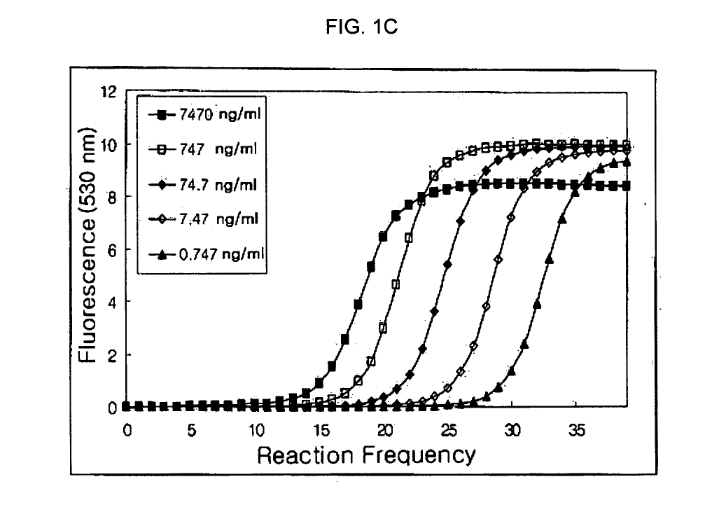

A Ct (threshold cycle) value, which represents the number of cycles when the concentration of the amplified sequence exceeds the set standard value, was obtained from the result of the real-time quantitative PCR. Then, the Ct values of the test samples thus obtained were plotted against the logarithmic value of the concentrations of the corresponding test sample, and the gradient and the intercept were figured out by employing the least square method. The calibration curves established based on the above result are shown in FIGS. 1A to 1C.

(3) Determination of Optimum Growth Conditions

The optimum conditions for the mycelial growth were established by selecting, as independent variables, the concentration of starch pulp substrate, the acidity (pH) of the medium, and the growth temperature, and examining the DNA growth rate (ng/ml/hr) of mushroom mycelia as function of the variables. Experimental conditions were set as shown in Table 2 and the DNA growth rates (ng/ml/hr) were measured by quantifying the amount of mushroom DNA using the real-time PCR method as described in (2) while the mushroom mycelia were cultivated in starch pulp liquid media under the conditions shown in Tables 3 to 5.

TABLE 2

| | Experimental Conditions | | |
|---|---|---|---|
| | Conc. | Acidity | Temp. |
| Mushroom mycelia | (g/l) | (pH) | (° C.) |
| Cordyceps militaris | 25˜45 | 5.5˜7.5 | 20˜30 |
| Ganoderma lucidum | 30˜50 | 4˜6 | 25˜35 |
| Phellinus linteus | 15˜35 | 4.5˜6.5 | 25˜35 |

TABLE 3
Experiment design for Ganoderma lucidum mycelia and result

| | Conc. | | Temp. | DNA growth rate |
|---|---|---|---|---|
| Experiment | (g/l) | pH | (° C.) | (ng/ml/hr) |
| 1 | 30 | 4 | 25 | 876 |
| 2 | 50 | 4 | 25 | 1187 |
| 3 | 30 | 6 | 25 | 643 |
| 4 | 50 | 6 | 25 | 834 |
| 5 | 30 | 4 | 35 | 59 |
| 6 | 50 | 4 | 35 | 123 |
| 7 | 30 | 6 | 35 | 34 |
| 8 | 50 | 6 | 35 | 64 |
| 9* | 40 | 5 | 30 | 1531 |
| 10 | 30 | 5 | 30 | 807 |
| 11 | 50 | 5 | 30 | 816 |
| 12 | 40 | 4 | 30 | 1364 |
| 13 | 40 | 6 | 30 | 619 |
| 14 | 40 | 5 | 25 | 2888 |
| 15 | 40 | 5 | 35 | 352 |

*Mean value obtained from three times of experiment

TABLE 4
Experiment design for Cordyceps militaris mycelia and result

| | Conc. | | Temp. | DNA growth rate |
|---|---|---|---|---|
| Experiment | (g/l) | pH | (° C.) | (ng/ml/hr) |
| 1 | 25 | 5.5 | 20 | 277.2 |
| 2 | 45 | 5.5 | 20 | 300.3 |
| 3 | 25 | 7.5 | 20 | 287.2 |
| 4 | 45 | 7.5 | 20 | 345.6 |
| 5 | 25 | 5.5 | 30 | 0 |
| 6 | 45 | 5.5 | 30 | 0 |
| 7 | 25 | 7.5 | 30 | 0 |
| 8 | 45 | 7.5 | 30 | 0 |
| 9* | 35 | 6.5 | 25 | 340.1 |
| 10 | 25 | 6.5 | 25 | 245.5 |
| 11 | 45 | 6.5 | 25 | 336.6 |
| 12 | 35 | 5.5 | 25 | 411.8 |
| 13 | 35 | 7.5 | 25 | 308.8 |
| 14 | 35 | 6.5 | 20 | 397.1 |
| 15 | 35 | 6.5 | 30 | 0 |

*Mean value obtained from three times of experiment

TABLE 5
Experiment design for Phellinus linteus mycelia and result

| | Conc. | | Temp. | DNA growth rate |
|---|---|---|---|---|
| Experiment | (g/l) | pH | (° C.) | (ng/ml/hr) |
| 1 | 15 | 4.4 | 25 | 839 |
| 2 | 35 | 4.5 | 25 | 387 |
| 3 | 15 | 6.5 | 25 | 825 |
| 4 | 35 | 4.5 | 25 | 3092 |
| 5 | 15 | 4.5 | 35 | 2638 |
| 6 | 35 | 4.5 | 35 | 3328 |
| 7 | 15 | 6.5 | 35 | 901 |
| 8 | 35 | 6.5 | 35 | 279 |
| 9* | 25 | 5.5 | 30 | 5576 |
| 10 | 15 | 5.5 | 30 | 1997 |
| 11 | 35 | 5.5 | 30 | 571 |
| 12 | 25 | 4.5 | 30 | 801 |
| 13 | 25 | 6.5 | 30 | 7169 |
| 14 | 25 | 5.5 | 25 | 32073 |
| 15 | 25 | 5.5 | 35 | 6156 |

*Mean value obtained from three times of experiment

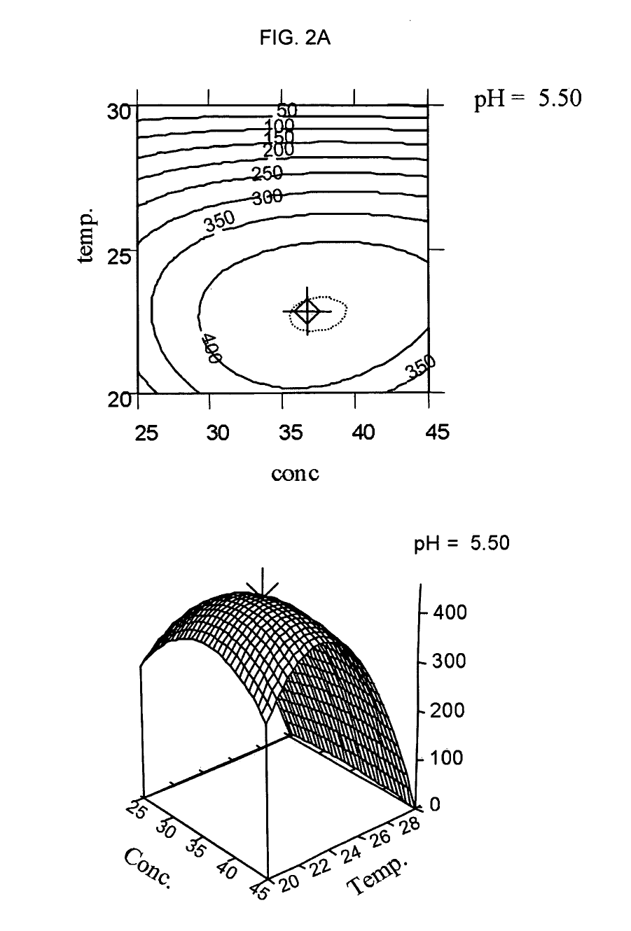

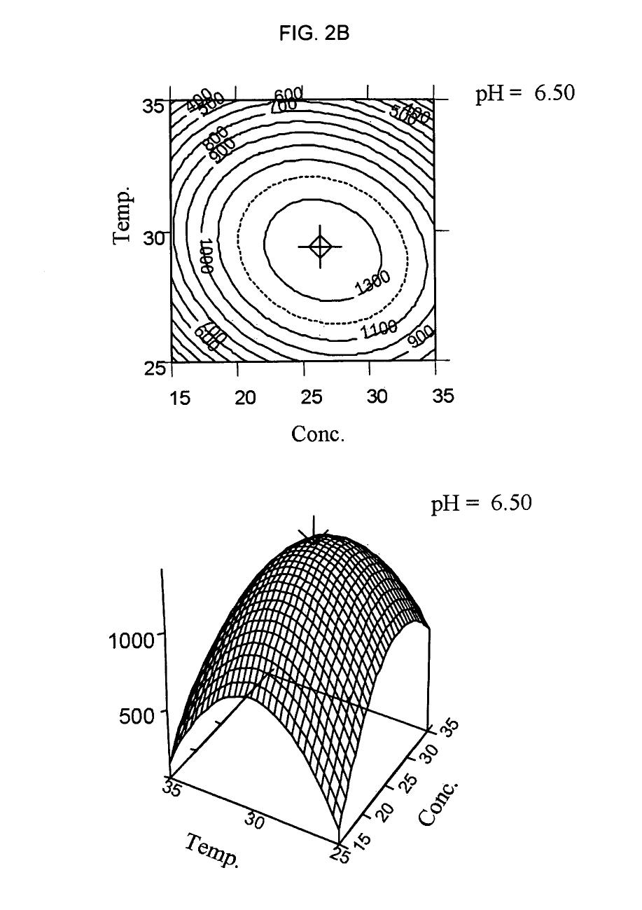

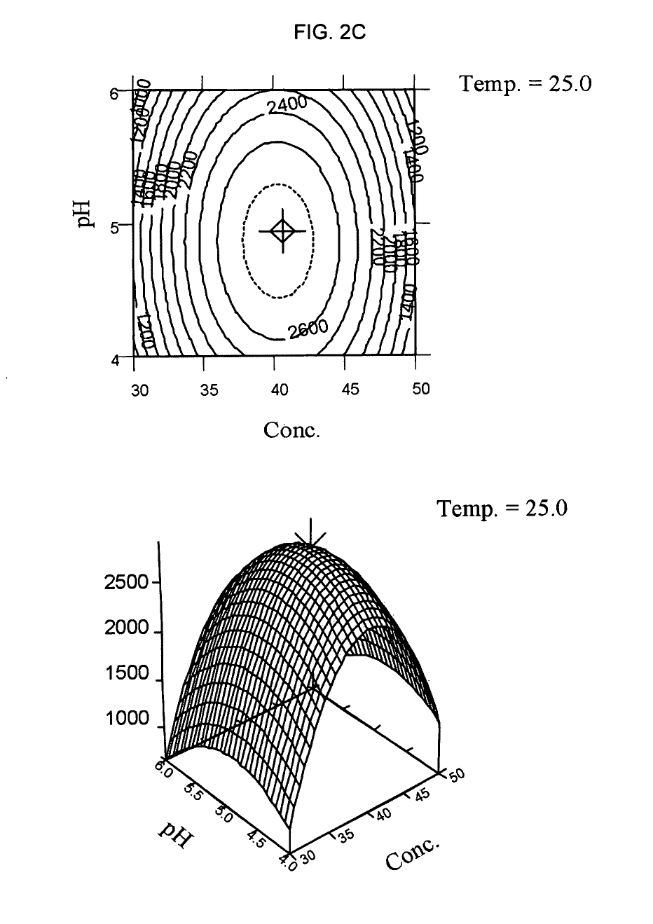

Contour plots and three-dimensional diagrams shown in FIGS. 2A to 2C were gained from the results shown in Tables 3 and 5 by the Response Surface Methodology (Hwang S. et al., Biotechnology and Bioengineering, 75; 521-529(2001), and optimum conditions for the growth of mushroom mycelia were established therefrom. The desirable conditions and optimum conditions for the growth of mushroom mycelia are shown in Tables 6 and 7.

TABLE 6

| | Desirable conditions for growth | | |
|---|---|---|---|
| | Conc. | Acidity | Temp. |
| Mushroom mycelia | (g/l) | (pH) | (° C.) |
| Cordyceps militaris | 30˜40 | 5.3˜5.9 | 20˜26 |
| Ganoderma lucidum | 35˜45 | 4.3˜4.8 | 22˜28 |
| Phellinus linteus | 24˜30 | 6.3˜6.5 | 26˜32 |

TABLE 7

| | Optimum condition | | | Expected maximum |
|---|---|---|---|---|
| | Conc. | Acidity | Temp. | DNA growth rate |
| Mushroom mycelia | (g/l) | (pH) | (° C.) | (ng/ml/hr) |
| Cordyceps militaris | 38.3 | 5.5 | 23.4 | 441.5 |
| Ganoderma lucidum | 40 | 4.6 | 25 | 3002 |
| Phellinus linteus | 26.4 | 6.5 | 29.2 | 7423 |

While the invention has been described with respect to the above specific embodiments, it should be recognized that various modifications and changes may be made to the invention by those skilled in the art which also fall within the scope of the invention as defined by the appended claims.

What is claimed is:

1. A method for producing mushroom mycelia, comprising cultivating mushroom mycelia in a liquid medium containing starch pulp as the sole growth substrate.

2. The method of claim 1, wherein the mushroom mycelia are cultivated under the condition of: starch pulp concentration ranging from 20 to 45 g/l, pH ranging from 4.0 to 7.0 and temperature ranging from 20 to 35° C.

3. The method of claim 1, wherein the mushroom is Cordyceps militaris, Ganoderma lucidum or Phellinus linteus.

4. The method of claim 1, wherein the mushroom is Cordyceps militaris and the mushroom mycelia are cultivated in a liquid medium under the condition of: starch pulp concentration ranging from 30 to 40 g/l, pH ranging from 5.3 to 5.9 and temperature ranging from 20 to 26° C.

5. The method of claim 1, wherein the mushroom is Ganoderma lucidum and the mushroom mycelia are cultivated in a liquid medium under the condition of: starch pulp ranging from 35 to 45 g/l, pH ranging from 4.3 to 4.8, temperature ranging from 22 to 28° C.

6. The method of claim 1, wherein the mushroom is Phellinus linteus and the mushroom mycelia are cultivated in a liquid medium under the condition of starch pulp ranging from 24 to 30 g/l, pH ranging from 6.3 to 6.5, temperature ranging from 26 to 32° C.

7. The method of claim 1, wherein the amount of mushroom mycelia is quantified by real-time quantitative PCR using primers specific for the DNA of mushroom mycelia during their cultivation.

8. The method of claim 7, wherein the DNA of mushroom mycelia is 18 s rDNA.

9. The method of claim 7, wherein the mushroom is Cordyceps militaris and the primers have the nucleotide sequences of SEQ ID NOs: 1 and 2.

10. The method of claim 7, wherein the mushroom is Ganoderma lucidum and the primers have the nucleotide sequence of SEQ ID NOs: and 4.

11. The method of claim 7, wherein the mushroom is Phellinus linteus and the primers have the nucleotide sequence of SEQ ID NOs: 5 and 6.
